(19) United States
(12) Patent Application Publication
(10) Pub. No.: US 2007/0036331 A1
(43) Pub. Date: Feb. 15, 2007

(54) Method and system for automatically synchronizing and auditing databases of telephone call center switching systems in a telephone call center network

(75) Inventor: Steven Craig Fitzgerald, Atlantic Mine, MI (US)

Correspondence Address: BROOKS KUSHMAN P.C., 1000 TOWN CENTER, TWENTY-SECOND FLOOR, SOUTHFIELD, MI, 48075, US

(73) Assignee: Consistacom, Inc., Houghton, MI (US)

(21) Appl. No.: 11/183,607

(22) Filed: Jul. 18, 2005

(51) Int. Cl. H04M 3/00

(52) U.S. Cl. 379/265.02

(57) ABSTRACT

A telephone call center system for directing incoming calls from callers to agents includes first and second call center switches such as ACDs and PBXs. The first switch has a configuration corresponding to call distribution rules such that the first switch distributes incoming calls from callers to the agents in accordance with the call distribution rules. A synchronizer is in communication with the switches for determining the configurations of the switches. Upon the synchronizer determining that the configuration of the second switch is different than the configuration of the first switch the synchronizer replicates the configuration of the first switch to the second switch such that the second switch has the same configuration as the first switch whereby both switches distribute incoming calls to the agents in accordance with the call distribution rules.

### BACKGROUND OF THE INVENTION

1. Field of the Invention

The present invention generally relates to telephone call centers.

2. Background Art

A telephone call center is an area of an organization where business is conducted by telephone in a methodical and organized manner. A call center is part of a telephone call center network. A call center network typically has many call centers which may be geographically distributed worldwide. Each call center of a call center network is historically based on the integration of a computerized database and at least one call center switching system such as an automatic call distributor (ACD) or a private branch exchange (PBX).

Call center switching systems such as ACDs and PBXs are specialized telephone systems for handling many incoming telephone calls. For example, an ACD recognizes and answers an incoming call and then accesses its associated database for instructions on what to do with the call. Based on these instructions, the ACD sends the call to a voice recording such as “the next available agent will be with you shortly” or to an interactive voice response (IVR) unit. The ACD then sends the call to the next available agent as soon as that agent has completed his/her previous call.

The ACD distributes incoming calls in some logical call flow pattern to a group of agents. Call processing instructions, which are patterned on business rules, are contained in the database associated with the ACD to define the call flow pattern. Typically, the call processing instructions define the call flow pattern such that calls are routed to the agents who are most likely to be able to assist the telephone callers (i.e., customers). Agents are persons that communicate with the callers on behalf of the organization. As such, agents in a call center are telephony end users that are members of an inbound, skills based, or programmable ACD group.

Call centers are subject to outages for a variety of reasons. Failure of the ACD of a call center, failure of the public telephone network carrier, failure of local application servers of the call center, etc., could leave agents of the call center idle while customer calls become disconnected or unanswered. As such, call center networks are configured to have failover capabilities in which calls to a failed call center are directed to an operational telephone call center in the call center network. This is done to provide the call center network with disaster recovery capability. A mix of failover capabilities means that at any given time a call center network may have individual sites (i.e., individual call centers) or even individual agents connected to a failover call center.

It is generally desired that the call processing instructions defining the logical call flow pattern are the same for each call center in a call center network. The same call processing instructions applied throughout the call center network provides business continuity. Business continuity across the ACDs of the call centers in the call center network is maintained when the ACDs handle calls identically. ACDs handle calls identically by distributing the calls to agents in accordance with a common logical call flow pattern. As such, it is desired that a failover call center handle calls in the same manner that a failed call center would have handled the calls. Consequently, as a result of business continuity being maintained across the ACDs, the caller experience is indistinguishable before and after a disaster event. A problem with call center networks is ensuring that business continuity is maintained at all times (i.e., under normal operations and when a disaster occurs).

Maintaining business continuity across the ACDs of a call center network enables for the desired operational results of consistency, quality, resiliency, and timeliness. Consistency is derived from ACDs handling calls identically at all times. A caller hears the same prompts and receives the same type and level of service regardless of which ACD handles their call. Consistency in a call center network having multiple ACDs is difficult to achieve and maintain using traditional management tools. Extensive testing and auditing of the call center network is required to accomplish consistency. Call handling problems arising from a lack of consistency are difficult and expensive to identify, track down, and repair.

Quality is based squarely on the perception of a caller's experience. Quality is what callers perceive in terms of appropriate, consistent handling of their telephone calls. Quality follows directly from the consistence of ACD configuration across the call center network.

Resiliency is more than having a redundant (i.e, a failover) ACD available to take calls in case of a disaster. Resiliency is the ability for the failover ACD to have up to the minute knowledge of agent configuration and call flow programming and to include multiple failover options. The result of resiliency is robust disaster recovery capabilities which assure that the call center network operations continue exactly as they were immediately prior to the disaster event. Resiliency also adds to the ability for individual call centers or even individual agents to activate their business continuity plan independently of other call centers in the call center network.

Timeliness is a measure of the time it takes to deploy a new or changed call flow. The traditional method of manually configuring multiple ACDs in a call center network results in rollout times measured in days or weeks. Timeliness is tied to consistency as slow manual changes create inconsistencies in active call flows.

As such, it is a goal to ensure that business continuity across the ACDs of the call centers in a call center network is maintained such that the call center network provides desired operational results for consistency, quality, resiliency, and timeliness when handling calls.

### SUMMARY OF THE INVENTION

Accordingly, it is an object of the present invention to provide a method and system for automatically synchronizing and auditing databases of telephone call center switching systems in a telephone call center network.

It is another object of the present invention to provide a method and system for automatically synchronizing and auditing databases of automatic call distributors (ACDs) in a telephone call center network.

It is a further object of the present invention to provide an enterprise scale management tool for a telephone call center network having a flattened IP architecture in which the tool provides synchronization among the ACDs in the telephone call center network in order to deliver increased resiliency for dealing with disasters in the call center network, improve the quality and consistency of a caller's experience, and lower the total cost of ownership of the call center network.

In carrying out the above objects and other objects, the present invention provides a telephone call center system for directing incoming calls from callers to agents. The system includes first and second call center switches such as ACDs and PBXs. The first switch has a configuration corresponding to call distribution rules such that the first switch distributes incoming calls from callers to the agents in accordance with the call distribution rules. A synchronizer is in communication with the switches for determining the configurations of the switches. Upon the synchronizer determining that the configuration of the second switch is different than the configuration of the first switch the synchronizer replicates the configuration of the first switch to the second switch such that the second switch has the same configuration as the first switch whereby both switches distribute incoming calls to the agents in accordance with the call distribution rules.

In response to the configuration of the first switch being changed to a new configuration corresponding to new call distribution rules such that the first switch distributes incoming calls from callers to the agents in accordance with the new call distribution rules, the synchronizer replicates the new configuration of the first switch to the second switch such that the second switch has the new configuration whereby both switches distribute incoming calls to the agents in accordance with the new call distribution rules.

In response to the configuration of the second switch being changed to a configuration which is different than the configuration of the first switch, the synchronizer replicates the configuration of the first switch to the second switch such that the second switch has the same configuration as the first switch whereby both switches distribute incoming calls to the agents in accordance with the call distribution rules.

The system may further include a third call center switch. In this case, the synchronizer is further operable for determining the configuration of the third call center switch. Upon the synchronizer determining that the configuration of the third switch is different than the configuration of the first switch the synchronizer replicates the configuration of the first switch to the third switch such that the third switch has the same configuration as the first switch whereby the switches distribute incoming calls to the agents in accordance with the call distribution rules.

Call center switch resources such as agent logins, vectors, virtual directory numbers, hunt groups, and announcements of the first switch are set in accordance with a resource group setting such that the first switch has the configuration corresponding to the call distribution rules. The synchronizer replicates the configuration of the first switch to the second switch such that the call center switch resources of the second switch are set in accordance with the resource group setting whereby both switches have the same configuration.

The call center switch resources of the first switch are set in accordance with a new resource group setting such that the first switch has the new configuration corresponding to the new call distribution rules. In this case, the synchronizer replicates the new configuration of the first switch to the second switch such that the call center switch resources of the second switch are set in accordance with the new resource group setting whereby both switches have the same new configuration.

Further, in carrying out the above objects and other objects, the present invention provides a system for use with a telephone call center network having call center switches such as ACDs and PBXs for directing incoming calls from callers to agents. The system includes a control points table, a subscriptions table, and a synchronizer. The control points table indicates which one of the switches is a publisher of a first resource and which one of the switches is a publisher of a second resource. The subscriptions table indicates which of the switches are subscribers of the first resource publisher and which of the switches are subscribers of the second resource publisher. The synchronizer is in communication with the switches and the tables. The synchronizer replicates the first resource of the first resource publisher to the subscribers of the first resource publisher and replicates the second resource of the second resource publisher to the subscribers of the second resource publisher in accordance with the indications of the tables.

The control points table further indicates the first resource of the first resource publisher. In response to a call systems administrator accessing the call distribution rules to modify the first resource indication the synchronizer replicates the modified first resource to the subscribers of the first resource publisher.

In response to the first resource of a subscriber of the first resource publisher being changed such that the first resource of the subscriber is different than the first resource of the first resource publisher, the synchronizer replicates the first resource of the first resource publisher to the subscriber such that the first resource of the subscriber is the same as the first resource of the first resource publisher.

Also, in carrying out the above objects and other objects, the present invention provides a method for a telephone call center system operable for directing incoming calls from callers to agents. The method includes providing a first call center switch having a configuration corresponding to call distribution rules such that the first call center switch distributes incoming calls from callers to the agents in accordance with the call distribution rules. The method further includes providing a second call center switch having a configuration. The method further includes communicating with the call center switches to determine the configurations of the call center switches using a synchronizer in communication with the call center switches. Upon determining that the configuration of the second call center switch is different than the configuration of the first call center switch, the configuration of the first call center switch is replicated from the synchronizer to the second call center switch such that the second call center switch has the same configuration as the first call center switch whereby both call center switches distribute incoming calls to the agents in accordance with the call distribution rules.

The above objects and other objects, features, and advantages of the present invention are readily apparent from the following detailed description when taken in connection with the accompanying drawings.

### BRIEF DESCRIPTION OF THE DRAWINGS

FIG. 1 illustrates a telephone call center network in accordance with a traditional architecture;

FIG. 2 illustrates a telephone call center network in accordance with a flattened Internet Protocol (IP) architecture;

FIG. 3 illustrates an architecture illustrating a basic ACD architecture and endpoint connections to gateways in the telephone call center network shown in FIG. 2;

FIG. 4 illustrates an IP endpoint failover design for a telephone call center network in accordance with the flattened IP architecture;

FIG. 5 illustrates a design having hot standby media servers with remote gateways for a telephone call center network in accordance with the flattened IP architecture;

FIG. 6 illustrates a 1×N resiliency design for a telephone call center network in accordance with the flattened IP architecture;

FIG. 7 illustrates a telephone call center network in accordance with the present invention;

FIG. 8 illustrates a network configuration of two telephone call center ACD sites of the telephone call center network shown in FIG. 7;

FIGS. 9A and 9B respectively illustrate control points and subscriptions tables which show the configuration of ACD resources to be synchronized between publisher ACDs and subscriber ACDs in accordance with the present invention;

FIG. 10 illustrates a telephone call center network in accordance with the present invention;

FIG. 11 illustrates a telephone call center network in accordance with the present invention; and

FIG. 12 illustrates the single point of programming provided by the multi-system synchronizer for the telephone call center networks in accordance with the present invention.

### DETAILED DESCRIPTION OF THE PREFERRED EMBODIMENT(S)

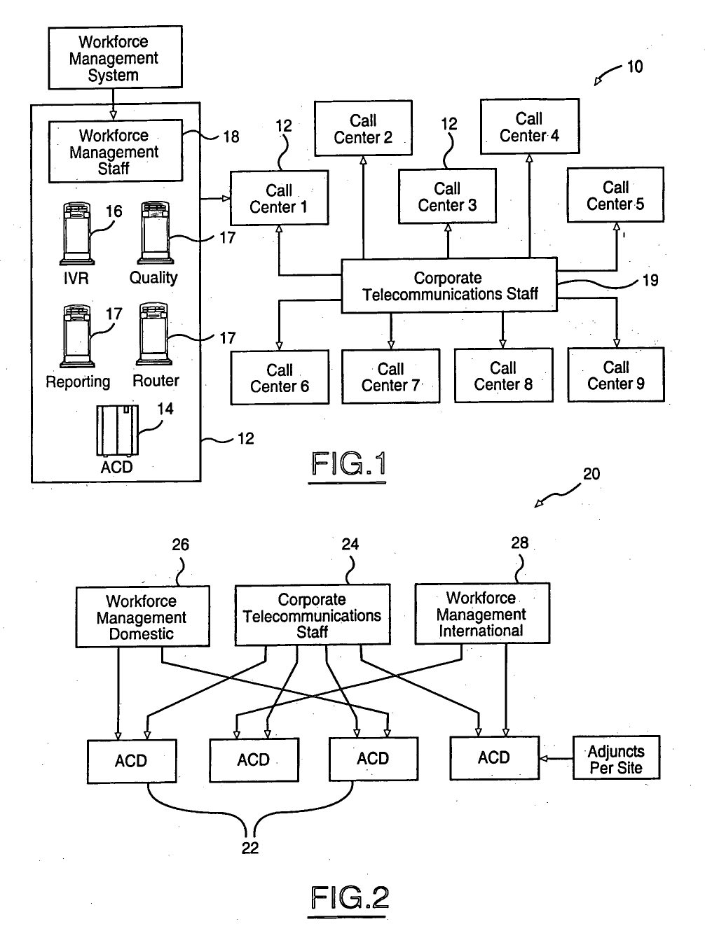

Referring now to FIG. 1, a telephone call center network 10 in accordance with a traditional architecture is shown. Call center network 10 includes a plurality of telephone call centers 12. Call centers 12 may be distributed locally, regionally, or worldwide. Each call center 12 generally includes an automatic call distributor (ACD) 14, an interactive voice response (IVR) unit 16, and application servers (or adjunct processors) 17 for reporting, quality, and routing functions. Each call center 12 has a workforce management staff 18 which are in communication with the various elements of the call center. Workforce management staff 18 of each call center are in communication with a workforce management system.

The elements of call center 12 are configured such that the call center provides a desired logical call flow pattern in response to incoming calls. Each call center 12 includes a plurality of agents to which incoming calls are routed in accordance with the logical call flow pattern. Call centers 12 communicate with a corporate telecommunications staff 19 to receive call flow pattern changes. Call system administrators manually configure the elements of their call center in accordance with the call flow pattern changes.

Corporate staff 19 is responsible for the initial addition and the definition of agents and station extensions. Corporate staff 19 also designs and programs the core of call centers 12 and the ACD resident call flow programming. Corporate staff 19 also maintains related resources such as recorded announcements and prompts. This particular task can be very intricate, especially when adjunct computer telephone integration (CTI), call audio recording, and management reporting systems are employed. The workforce manager manages the assignment of individual login identifiers to agents, and maintains the related agent skill and proficiency information whether or not a performance based agent management system is in use.

Call center network 10 in accordance with the traditional architecture is generally characterized as having a complex and ineffective administration. This is because each call center 12 requires administration, manpower, and servers and call flow pattern changes are difficult to coordinate among the call centers. Further, call center network 10 has an unacceptable disaster recover capability as failure of an ACD 14, the public telephone network carrier, or the local servers could leave many agents idle while incoming calls become disconnected or unanswered.

Referring now to FIG. 2, a telephone call center network 20 in accordance with a modern, flattened IP architecture is shown. Call center network 20 includes a plurality of telephone call centers having ACDs 22. The call centers may be distributed worldwide. The call centers further include an IVR unit and media servers for reporting, quality, and routing functions. The call centers communicate with a corporate telecommunications staff 24 to receive call flow pattern changes. A domestic workforce manager 26 manually configures the logical call flow pattern provided by ACDs 22 of the domestic call centers in accordance with the call flow pattern changes. Similarly, an international workforce manager 28 manually configures the logical call flow pattern provided by ACDs 22 of the international call centers in accordance with the call flow pattern changes.

Call center network 20 in accordance with the modern, flattened IP architecture is generally characterized as having a reliable disaster recovery foundation. This is because the IP telephone sets and other endpoints at each call center (where the agents reside) are configured to first connect with their primary ACD 22. However, the endpoints are additionally configured to automatically failover to another ACD of a different call center if they cannot connect with their primary ACD for any reason. Call center network 20 has a reduced telecom staff complexity and an increased workforce management complexity as compared with call center network 10.

The flattened IP architecture of call center network 20 is an architecture advanced by Avaya Inc. The flattened IP architecture combines many recent advances in technology such as IP telephony into a design that reduces the cost of creating resilient and scalable virtual call centers. The flattened IP architecture has the following design highlights. Many small ACDs are replaced by fewer but more powerful and capable ACDs. The number of adjunct application instances that are required along with their associated servers are reduced. Expensive public network toll-free advanced services such as call takeback and transfer are replaced by inexpensive basic services. Complex multi-tiered routing schemes designed for managing expensive toll-free networks are eliminated. Agents can be located anywhere broadband data access facilities are available, domestically or internationally. Both agents and management can be served by the same switching platform.

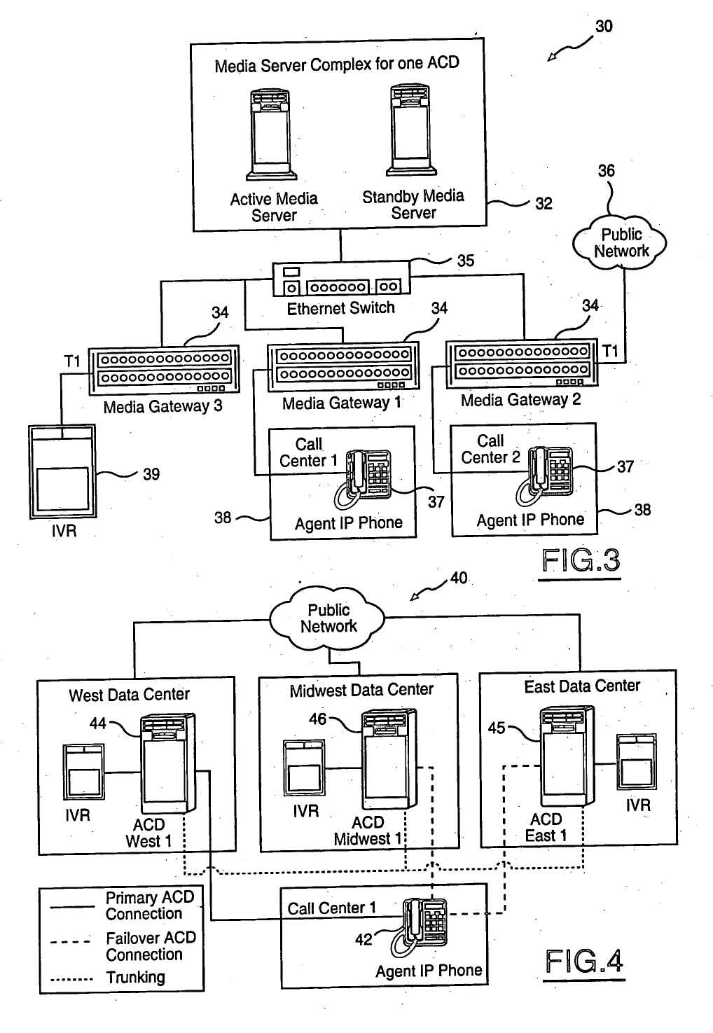

Referring now to FIG. 3, with continual reference to FIG. 2, an architecture 30 illustrating a basic ACD architecture and endpoint connections to gateways in call center network 20 is shown. Call flow processing and agent selection logic reside in a pair of redundant media servers 32. Media gateways 34 connect to media servers 32 via a switch 35. Media gateways 34 connect to the public telephone network 36 and to media gateways on other ACDs as needed. Agent telephones 37 in call centers 38, an IVR unit 39, and adjunct processors (not shown) connect to public telephone network 36 and each other through media gateways 34.

Media gateways 34 can be equipped to connect to a variety of agent telephone types such as IP telephones, IP based soft telephones running on personal computers, digital telephones, and analog telephones. IVR 39 unit also connects to media gateways 34 as indicated above. These connections are collectively referred to as endpoints. IP-based endpoints are equipped with internal failover logic. If a media gateway 34 or the IP network connecting the endpoint to the media gateway fails, then the endpoint will search out the first available alternate media gateway based on a pre-configured failover list. The IP endpoint reconnects to this failover media gateway and service will still be provided. For example, telephone call center “1” has a primary ACD connection to media gateway “1”. If this ACD connection is disrupted, then telephone call center “1” is connected with media gateway “2” via a failover ACD connection.

Media gateways 34 connect to media servers 32, and to each other, via IP networking. The failover protocol with media gateways 34 operates on similar principles to the IP endpoints, seeking out the first working media server complex with a pre-configured list. This triple layered protection scheme allows a business continuity plan to be tailored for an enterprise's unique needs. A fully flattened, IP-based, multi-site telephone call center typically includes multiple media server complexes located in geographically diverse data centers with only a technical staff. The media servers complexes are in turn attached to co-located media gateway farms. The combination of a media server complex and its connected media gateways is a single ACD. The IP telephone sets and other endpoints at each telephone call center site (where the agents are located) are configured to first connect with one of multiple gateways in the preferred data center. The endpoints are additionally configured to automatically failover to an ACD in a different data center if they cannot connect with their primary ACD for any reason.

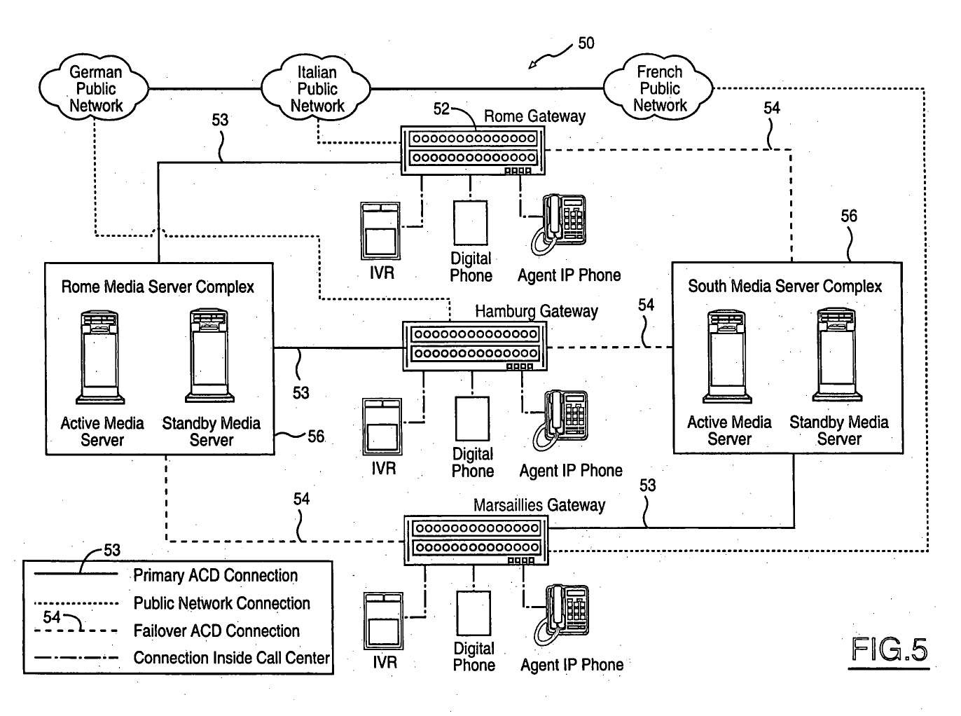

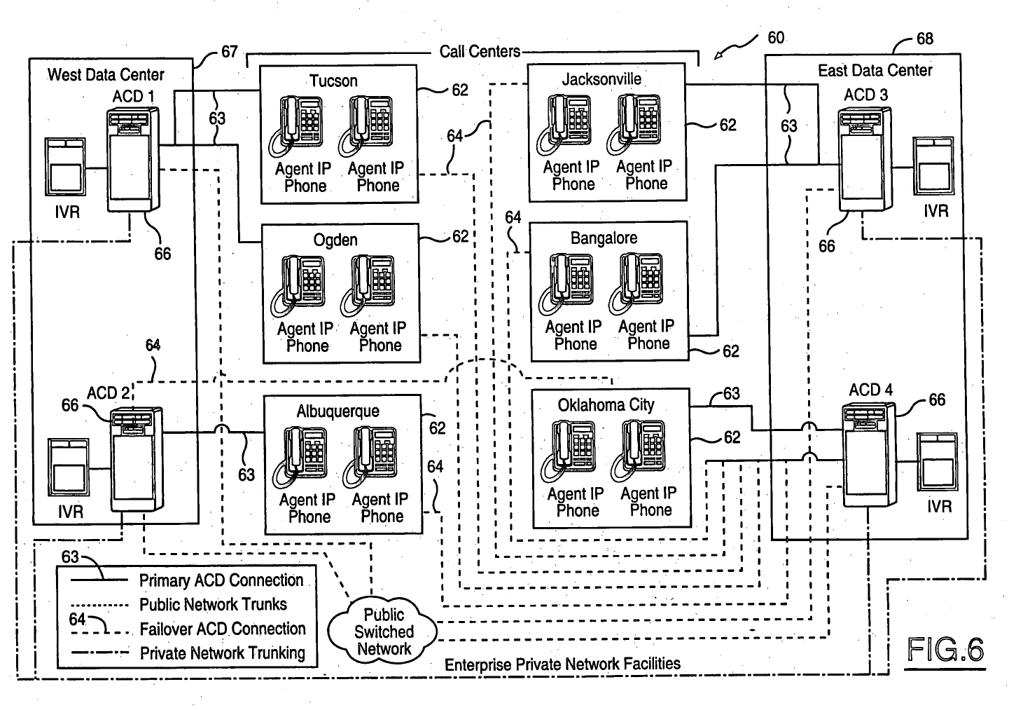

FIGS. 4, 5, and 6 respectively illustrate three examples of how failover capabilities are implemented in multi-site virtual telephone call centers based on the flattened IP architecture. FIG. 4 illustrates an IP endpoint failover design 40 for a call center network in accordance with the flattened IP architecture; FIG. 5 illustrates a design 50 having hot standby media servers with remote gateways for a call center network in accordance with the flattened IP architecture; and FIG. 6 illustrates a 1×N resiliency design 60 for a call center network in accordance with the flattened IP architecture.

In IP endpoint failover design 40 shown in FIG. 4, an agent telephone 42 automatically seeks out an available gateway co-located with media servers and IVRs. If agent telephone 42 loses its connection to its primary ACD 44 (“ACD West 1”), then the agent telephone automatically seeks its secondary ACD 45 (“ACD East 1”). As a tertiary failover, if ACD East 1 is not available due to the outage, then agent telephone 42 seeks its tertiary ACD 46 (“ACD Midwest 1”). The ACD search sequence carried out by agent telephone 42 is predefined.

In design 50 of hot standby media servers with remote gateways shown in FIG. 5, gateways 52 of the call centers automatically seek their alternative media server 56 when a connection fails. The IP endpoints (e.g., IVR, digital phone, agent IP phone) are always connected to their local gateway. For example, Rome gateway 52 has a primary ACD connection 53 to Rome media server 56. If this connection fails, then Rome gateway 52 seeks to connect to Southern media server 56 via a failover ACD connection 54.

In the 1×N resiliency design 60 shown in FIG. 6, each call center 62 is assigned to one of four ACDs 66 as a primary server and is also assigned to one or more failover ACDs. (The “1×N” designation denotes 1 backup system for one or more active (or primary) systems.) For example, Albuquerque call center 62 has a primary ACD connection 63 to the ACD #2 located in a West data center 67 and has a failover ACD connection 64 to the ACD #4 located in an East data center 68. As shown in FIG. 6, ACDs #1, #2, and #3 are heavily loaded while ACD #4 is lightly loaded and is ready to serve telephone call centers that cannot reach their primary ACD. The few agents that use ACD #4 as their primary ACD also use ACD #2 as their failover ACD. All IP phones within telephone call centers 62 independently perform their failover function in concert if their call center becomes disconnected from the primary ACD. It is also possible for each call center to have more than one designated failover ACD.

As described, the flattened IP architecture makes the flexible IP connection failover possible. This flexibility is necessary to create a successful business continuity plan for a call center network, but is not sufficient to maintain the business continuity plan by itself. For business continuity to work at all, the failover ACD (i.e., the failover media server) must know that the agent login ID and telephone extension actually exist. Nothing in the flattened IP architecture as described hence far automatically transfers that information between active ACDs. To work successfully, especially in a dynamic performance-based call center, the failover ACD (i.e., the failover media server) needs up to the minute information about the agent's queue (skill) assignments, level of proficiency, and call selection characteristics. Call flow programming information and announcements must also be synchronized among all the ACDs. Experience has repeatedly proven that this synchronization task is beyond human capability. Only an intelligent, automated, enterprise level tool can do the job properly and accurately.

Configuring a single ACD to serve a multi-mission virtual telephone call center is not a trivial task. A clear statement of the missions the call center must accomplish, the service levels to be delivered, and the detailed call flows that support both must be articulated and designed. However, this is only the starting point. A cadre of highly skilled technical staff assisted by professional service provides must then allocate and assign resources of different types to each call flow. These resources must be tied together with ACD resident programming and the results thoroughly tested.

Once the call flows are in place and in use, the business organization operators inevitably demand changes to be made. These requests involve the usual change control issues and their costs. These issues are further complicated by the fact that most organizations lack effective enterprise-level reporting and the query tools that must be used to examine the current ACD configurations and verify that the changes were made correctly. Lack of proper tools coupled with poor record keeping found in many voice communications organizations often results in slow and error-prone changes. Inconsistencies arise, even if only temporarily, and affect quality.

This inaccurate ACD configuration and programming, even in a single ACD enterprise, affects both quality and consistency resulting in: unhappy customers, reduced caller to agent match rates, increased agent time in handling calls, and reduced revenue in the call centers.

In a large business enterprise, it is common to find the same mission and associated call flows distributed across several ACDs. This is true even if the business continuity plan does not include any of the failover techniques described above. Two examples of similar missions and call flows include: 1) branch banking, where many small PBXs provide the same set of services to hundreds of locations; and 2) insurance, where dozens of regional service offices provide common call flows.

The need to maintain common call flows on multiple ACDs and PBXs increases the chances for error and subsequently increases the cost of managing the change. That is, the more ACDs and PBXs the more likely it is that errors and their associated costs will be encountered. In a virtual call center, a flattened IP architecture reduces the number of ACDs to manage, but does not minimize the possible errors related to the maintenance of common call flows.

The flattened IP architecture enables common queuing of calls by the ACDs of a virtual call center to thereby improve agent match rates and drive down operating costs. However, the flattened IP architecture can only deliver the maximum benefit when all of the ACDs are programmed identically and the agent performance data for each agent is updated and maintained periodically (such as daily) on both the primary and failover ACDs. Assuming that timely and accurate administration of all the ACDs of the virtual call center was possible with traditional tools operating on one ACD at a time, the total cost of ownership of the virtual call center would still be higher than necessary. This is because each of the ACDs has an associated administrative burden. For example, each of four ACDs in a virtual call center would have an associated administrative burden when using traditional tools for timely and accurate administration of the ACDs.

An enterprise scale management tool in accordance with the present invention reduces the administrative burden of the four ACDs, in the example, to a single virtual ACD. The enterprise scale management tool in accordance with the present invention ensures consistency and quality among all of the ACDs by individually and consistently maintaining the ACDs with the latest call flows and agent performance information. As a result, multiple ACDs deliver the considerable benefits of a single virtual ACD. In sum, the enterprise scale management tool in accordance with the present invention provides a larger reduction in administration costs while automatically achieving consistency, quality, and business continuity plan compliance for the ACDs.

It is unusual, even in the largest enterprise, to find more than a handful of operators who completely understand the operational and configuration details necessary to successfully implement and maintain a workable business continuity plan for the ACD portion of a call center, virtual or otherwise. An enterprise with a clearly defined business continuity plan, well developed and tested procedures, and a well trained staff of operators can achieve an acceptable level of consistency and timeliness in a single ACD environment.

However, when one or more additional ACDs must be administered, the timeliness and accuracy of the manual effort will falter. The lack of foresight in designing the virtual call center numbering plan (for agents, stations, announcement, etc.), coupled with the casual assignment of load sensitive resources (such as voice announcements) leads to mistakes. These faults can appear in the overall plan used for designing call flows, the dial plan resource numbering allocations, and sometimes even in the determination of which ACD will be the primary server for a telephone call center. New management procedures required for managing a multi-ACD enterprise will likely conflict with the original procedures. Thus, the probability of the business continuity plan working successfully greatly diminishes. As the assignment rules become more complex and the number of ACDs increases, delays and mistakes compound, often substantially. ACDs do not provide any form of business rules validation (checking) which allows many mistakes to lay dormant until a business interruption occurs and the business continuity plan is invoked. Deviation from the business continuity plan's requirements for ACD configuration can result in complete breakdowns of some call flows when a disaster occurs. Until then, the more obvious mistakes will manifest themselves during normal operation as occasional mis-handled calls. This type of error is particularly hard to identify and can infuriate callers while baffling agents and management for a long time before being discovered.

Day to day management issues aside, management has no way to know if the multi-ACD telephone call center is in compliance with corporate business continuity requirements. However, the enterprise scale management tool in accordance with the present invention provides an automated, enterprise-level auditing tool for reliably verifying business continuity compliance.

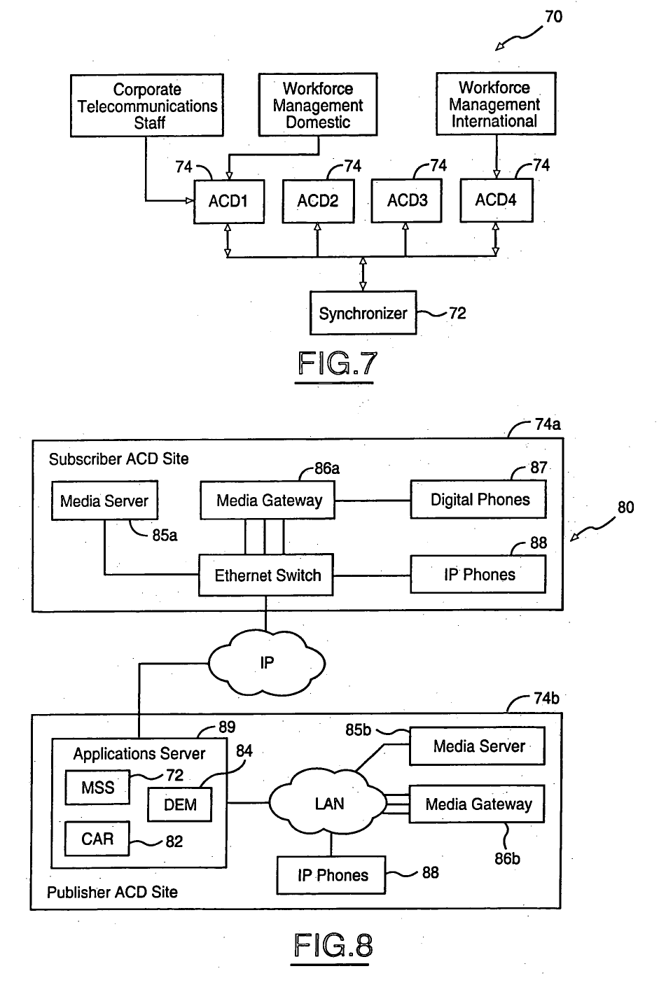

Referring now to FIG. 7, a telephone call center network 70 in accordance with the present invention is shown. Initially, it is noted that call center network 70 is based on the flattened IP architecture (compare with call center network 20 shown in FIG. 2). Call center network 70 deviates from the traditional flattened IP architecture by incorporating a multi-system synchronizer (“MSS”) 72 in accordance with the present invention. In general, MSS 72 is the enterprise scale management tool introduced above and converts call center network 70 into an automated call center having ACD synchronization. ACD synchronization, in accordance with the present invention, is defined as the replication of selected ACD configuration information across multiple ACDs according to a pre-defined set of business rules in real-time and at scheduled intervals. (In MSS 72, the real-time and scheduled components are both employed with the scheduled function backing up the real-time function.) With MSS 72 in place, administrative staff need only to define an ACD configuration on a primary ACD and the MSS automatically populates or replicates this ACD configuration to alternative ACDs.

MSS 72 includes a real-time synchronization component which provides automatic real-time synchronization of ACDs 74 of call center network 70. That is, MSS 72 provides automatic real-time synchronization of all ACD configuration activity necessary for business continuity plan compliance. MSS 72 also includes an auditing (i.e., a scheduled synchronization) component which performs a nightly audit, automatically correcting and reporting any deviations that may have arisen during the day. (Nightly audits of a perfectly operating multi-switch environment will not typically find any deviations because the real-time synchronization component prevents them from occurring. Network components break down and people make mistakes, leading to deviations. The auditing component finds them.) MSS 72 enables an associated enterprise-level real-time reporting feature which allows management access to information formerly difficult to obtain or simply not available.

The real-time and scheduled (i.e., auditing) synchronization components of MSS 72 are separate and complimentary applications with separate configuration tables. Ideally, the real-time synchronization component of MSS 72 is all that would be required to maintain synchronicity among the ACDs of a call center network. However, this idea environment is unavailable as failures of ACDs, data networks, application server hardware, application software, data stores, etc., frequently occur. The real-time synchronization component of MSS 72 is provided as the primary means of keeping secondary ACD configurations in step with the primary ACDs. The scheduled synchronization component of MSS 72 “catches up” any synchronization that was missed during the day and also takes care of those few synchronization situations which the real-time synchronization component of the MSS cannot handle.

As such, the real-time synchronization component of MSS 72 attempts to synchronize all qualified ACD/PBX administration activity immediately. The auditing component of MSS 72 performs a complete examination and synchronization of ACD/PBX systems as described by business rules encoded in configuration tables. This serves as a safety net under the real-time synchronization component of MSS 72, which might have been impaired by various system failures during the day. The combination of the real-time and scheduled (auditing) synchronization overcomes both inherent operational characteristics and operational impairments of the ACD/PBX systems that prevent real-time synchronization from succeeding in every case. The auditing component is also used to perform the initial synchronization across the enterprise, and can be used to perform a pure audit (without synchronization) for business continuity assessments.

MSS 72 provides for configurable limits on the maximum elapsed time allowed for scheduled synchronization, and provides for configurable latest ending times for scheduled synchronization. Both types of limits are intended to confine scheduled auditing/synchronization activities to user defined “maintenance windows” if desired.

Both the real-time and scheduled synchronization components of MSS 72 can be run in a simulation mode. In the simulation mode, the synchronization components determine and identify what resources of the ACD/PBX systems need to be synchronized without actually performing the synchronization. This directly yields an audit only capability.

When first installed, MSS 72 is configured to run in a pure audit mode to identify all business continuity plan deviations. During this audit-only pass over a large enterprise, it is typical to find thousands of deviations resulting from manual configuration procedures. MSS 72 then runs in a production mode to correct the deviations.

When the initial synchronization process is complete, the administration groups continue their jobs, using the same tools as before. An advantage of MSS 72 is that it requires minimal change in procedure and no additional training for anyone, except those designated to check daily synchronization results. Each administration group pursuing its own goals within the bounds of the business continuity rules automatically, via MSS 72, keeps all the ACDs updated by operating only on one ACD. When the skills (queues) assigned to an agent are updated on that agent's primary ACD, MSS 72 automatically updates all failover ACDs in seconds. As a result, if a network failure occurs and the agent's phone automatically reconnects to its assigned failover ACD, then all calls continue flowing exactly as they did immediately before the failure. This is the way a virtual call center should be managed—doing the change management paperwork and the change itself only once.

The extensive audit trail capability within MSS 72 provide management information not only about what items were changed and when, but also who changed the items. MSS 72 also enables a real-time view of the automatic synchronization activity of the MSS. MSS 72 also enables the availability of on-demand ACD (and PBX) configuration reporting data.

When using MSS 72, the management and administration components of ownership cost are reduced to the lowest possible level while automatically keeping consistency and quality at the highest level. Existing management reports of call center effectiveness increase in value because there is visibility not only of results, but the configuration that produced them.

The return on investment experienced when using MSS 72 is generated by cost savings, cost avoidance, and enhanced revenue derived from four basic areas of improved operation and administration: business continuity plan adherence, consistent call routing, centralized administration, and real-time reporting.

MSS 72 improves business continuity/disaster recovery operation by doing the following. MSS 72 fully synchronizes agents, vectors, VDNs (virtual directory numbers), hunt groups, and announcements (announcement administration and announcement audio files) on a real-time basis which ensures automatic compliance with the business continuity plan. MSS 72 enables daily management reports which show what components were out of compliance. This reduces the need for massive manual (and error prone) compliance audits. MSS 72 enables the availability of a pure audit capability to assess the impact and compliance of modifications made to the business continuity plan. Actual changes do not have to be made to actually see their impact on the business continuity plan.

MSS 72 provides consistent call routing and handling by doing the following. MSS 72 eliminates lost calls, high queue times, and wasted agent time when an ACD of call center 70 is operating in failover mode. MSS 72 ensures a consistent call experience for callers, regardless of where the call enters call center 70. MSS 72 avoids the high costs for administration staff which are responsible for troubleshooting errors resulting from call flow inconsistencies. MSS 72 enables the rapid, accurate, and efficient spread of call loads across available resources (including new ACDs), reorganizes agents according to business rules, and even changes the disaster recovery plan easily and automatically.

MSS 72 provides for centralized administration by doing the following. MSS 72 avoids failover failures by ensuring that agent changes are accurate on all ACDs of telephone call center 70. MSS 72 enables new products and procedures to be rolled out quickly and accurately in response to competitive pressures, saving days, weeks, or months compared to existing tools. MSS 72 performs nightly audits to eliminate the opportunity for errors and deviations to creep in over a period of time. MSS 72 provides for real-time reporting and management as the MSS provides a single data source, always up to date, for reporting ACD configuration data.

As indicated above, the flattened IP call center architecture has proven itself a highly desirable design that reduces the costs of creating resilient and scalable virtual telephone call centers. Not only can smaller ACD systems be replaced by fewer, larger ACD systems, but the associated costs normally required for older architectures is eliminated. Call center agents can now be located anywhere across the world allowing the business to take full advantage of reduced labor and location costs. However, while the benefits of the flattened IP call center architecture can be substantial, they can only be fully realized with proper system management and administration. The complexities of managing a multi-ACD telephone call center are enormous. Manual administration on a per ACD basis is daunting and error-prone. The addition of MSS 72 overcomes these management and administration obstacles.

MSS 72 provides administrative savings by automatically synchronizing, in real-time, all ACD configuration activity. As a result, MSS 72 assures business continuity plan compliance and enables consistent call handling as the norm. The enterprise-level real-time reporting feature enabled by MSS 72 allows management access to information formerly very difficult to obtain or simply not available. In short, MSS 72 adds consistency, quality, and resiliency to the call centers of call center network 70.

MSS 72 has the following features. First, MSS 72 provides a single point of programming in which administration on a primary ACD (or PBX) is instantly replicated to designated failover ACDs (or PBXs). Second, MSS 72 is transparent in that telecommunications staff of the call center network can continue to use their traditional administrative interfaces. As such, no training or procedural changes are required when incorporating MSS 72 into the call center network. Third, MSS 72 provides for business continuation compliance in that failover ACDs (or failover PBXs) are compared to their primary every night. MSS 72 corrects and reports any deviations. Fourth, MSS 72 has call center network flexibility in that the MSS supports active/standby, 1×N, and load sharing (bi-directional synchronization) call center network configurations. As such, MSS 72 enables multiple synchronization techniques (hot standby, load sharing, 1×N) to be concurrently implemented within a network of call center switches. Different techniques can be specified for different resource types and even different ranges within the same switch. Fifth, MSS 72 provides for auditing in by having a database of all MSS initiated changes including ACD (or PBX) feedback. Sixth, MSS 72 enables multi-user, real-time monitoring of all activity in the call center network and provides an archive of past activity that can be searched and replayed. Seventh, MSS 72 provides for visibility by enabling a single source ODBC access to the configuration of the entire call center network.

MSS 72 generally synchronizes the following types of resources among ACDs (and PBXs) in a call center network: ACD agent logins, ACD skills/PBX hunt groups, announcements, stations, trunks and trunk groups, VDNs (virtual directory numbers), vectors, etc. This synchronization means that the user communities of the call center network are able to maintain up to the minute call processing strategies and agent configurations on their alternate servers. This allows each community to gracefully re-register to an alternate server with the assurance that configurable ACD (PBX) resources on the alternate server are already configured as they had been one the failed (or perhaps simply unreachable) primary server. An assumption for MSS 72 is that all of the ACDs (or PBXs) in the call center network have identical configurations with the same hardware (every carrier, circuit pack or blade is in the same slot), software, adjuncts, and numbering schemes.

Policy based agent management provided by MSS 72 to call center networks has the following characteristics. First, agents are defined by their business function and not in ACD terms. Second, individual agent administration is replaced with policy definition by business function (i.e., sales, saves, customer service, etc.). Third, the entire agent population is checked for policy compliance every night (or on demand) and ACD administration is automatically adjusted. As a result, a day's tactical policy deviations are automatically recovered, agents start each day configured by the current policy, and a complete audit trail and agent history is accessible. Fourth, MSS 72 can be integrated with workforce management systems or can be used independently for smaller call center networks. Fifth, MSS 72 can be integrated with agent performance management systems. Consequently, increased ACD match rates based on the latest agent performance data translate to increased revenue and quality for a call center network.

Referring now to FIG. 8, with continual reference to FIG. 7, a network configuration 80 of two telephone call center ACD sites 74a, 74b of telephone call center network 70 is shown. With reference to FIG. 8, the configuration steps required for MSS 72 and a configuration archive (CAR) application 82 to successfully interoperate with call center ACD sites 74a, 74b using a Directory Enabled Management (DEM) 84 application will be described. The DEM application is provided by Avaya, Inc. In general, MSS 72 synchronizes call center related moves, adds, and changes (MACs) between ACD resources of call center ACD sites 74a, 74b; and CAR 84 archives and retrieves the MACs details from the call center ACD sites.

MSS 72 automatically provides a copy of all critical call center ACD site resources on one or more failover call center sites by synchronizing the call center management data from one call center ACD site to all other call center ACD sites. MSS 72 provides a single point of programming for globally defined and utilized resources such as vectors for call routing and their associated VDNs configured for the call center sites. CAR 82 captures a complete configuration history of call center ACD site resources across the entire enterprise of call center ACD sites. Whenever something changes, the new configuration settings are recorded in the archive. MSS 72 and CAR 82 communicate with DEM 84/lightweight directory access protocol (LDAP) data store to retrieve call center ACD information and provide synchronization and archival of the ACD moves, adds, and changes within the call center ACD sites. It is noted that CAR 82 uses COBRA based communications protocols and relational database and SQL.

MSS 72 is built on DEM 84. DEM 84 provides a real-time image of communications systems across the enterprise. That is, a primary function of DEM 84 is the creation and maintenance of ACD (PBX) configuration in an electronic directory which is referred to as ACD directory. The ACD directory is an electronic directory representation of the current ACD configuration. After initial synchronization, the ACD directory automatically updates itself with ACD changes as they occur.

MSS 72 uses a “publish and subscribe” metaphor. A publisher ACD is an ACD that publishes and offers objects for replication to all other ACDs. That is, a publisher ACD is an ACD with the authoritative copy of an object to be synchronized. Humans only administer the objects of a publisher ACD while MSS 72 is employed. A subscriber ACD is an ACD that requests replication of objects from a publisher ACD to itself. That is, a subscriber ACD is an ACD to which an object is synchronized. Synchronization is the replication of an object or resource from a publisher ACD to subscriber ACDs under control of business rules. The objects to be synchronized in the multiple ACD environment include agents (ACD agent logins), VDNs, announcements (announcement administration and announcement files), vectors, hunt groups, stations, trunks, and other resources. A business rule is a business continuity plan requirement stated in terms of publishing and subscribing ACDs to control synchronization. Resilient business continuity enables the caller experience to be indistinguishable before and after a disaster event.

In the network configuration shown in FIG. 8, call center ACD site 74b is a publisher ACD and call center ACD site 74a is a subscriber ACD. Each ACD site 74a, 74b includes a media server 85 and a media gateway 86 the combination of which is a single ACD. ACD sites 74a, 74b further include digital phones 87 and IP phones 88. An applications server 89 is placed at publisher ACD site 74b. MSS 72, CAR 82, and DEM 84 are co-resident on applications server 89 (but may be resident on different servers). In order to provide DEM connectivity to both ACD sites 74a, 74b, applications server 89 is connected to both ACD sites via IP links.

As noted above, MSS 72 and CAR 82 support the synchronization and archival of the following types of call center ACD resources which include, but are not limited to: ACD agent login ID, announcements, skill (hunt group marked as skill), vector directory number (VDN), vector, and class of service (COS). MSS 72 synchronizes these resources between ACD sites 74a, 74b.

MSS 72 provides both real-time and scheduled synchronization of the ACD resources via two separate applications. The first application is the real-time synchronization application which is the “first line” of synchronization within MSS 72. The real-time application of MSS 72 replicates, in real-time, day to day changes made on primary ACD site 74b to subscriber ACD site 74a. The second application is the scheduled synchronization application (i.e., the audit application) which compares the ACD resources on the primary and subscriber ACD sites 74b, 74a and, at a scheduled time, corrects and logs discrepancies of the subscriber ACD site 74a such that the ACD resources on the primary and subscriber ACD sites 74b, 74a are synchronized.

As noted, MSS 72 uses a publish and subscribe metaphor coupled with the notion of “control points” for selecting and controlling which ACD resources are to be synchronized. A control point is an ACD resource instance (e.g., an ACD login ID 230001) offered for replication by a publisher ACD to subscriber ACDs. As such, control points are resource types and ranges which are published for replication. A publisher ACD offers control points for subscriber ACDs. Subscriber ACDs request replication of a control points from a publisher ACD to itself. As such, “subscriptions” define the ACDs to be synchronized with control points.

The synchronization provided by MSS 72 is the replication of resource configuration information from a controlling communication system to others. MSS 72 can provide the replication to be verbatim (“direct sync”) or with adjustments applied (“adjusted sync”) to accommodate differences in numbering plans, assignment ranges, or even resource types. Direct sync always operates between communications systems of the same type. Once example is an IP station on ACD A replicating to ACD B and ACD C. Adjusted sync can be implemented to operate between certain groupings of dissimilar types (example: ACD station to an ACD and a voice mailbox).

The synchronization provided for by MSS 72 in accordance with the present invention flows from a controlling resource (also known as a control point) to one or more replicants. (Example: ACD A is the control point for all announcements, while ACD B and ACD C are the replicants. Changes to an announcement on ACD A are replicated to ACD B and ACD C.) The notion of a control point is employed for the following reasons. First, the nightly audit process needs to understand which system's resource is the authority. As such, if ACD A, ACD B, and ACD C all have a different COR for agent 12345 and no control point was defined, then it would be impossible to know which systems were out of compliance. Second, “races” might occur if ACD A and ACD B are changed at about the same time and the goal is to implement an “any change, anywhere” type of replication. As such, an administrator could change agent X's COR to five on ACD A while another administrator could change agent X's COR to ten at about the same time. Third, without a control point, there is the likelihood of replication loops. For example, ACD is changed and replicates to ACD B and ACD C. An error in programming logic or sync configuration could then lead to ACD B trying to update ACD A and ACD C. When ACD A sees the update it would replicate again to ACD B and ACD C, etc.

A given ACD may be both a publisher and a subscriber of control points so long as no loops are created. For any globally unique resource identifier in the enterprise ACD environment no more than one ACD can be declared as the control point. An ACD may be the control point for some resources yet not others. Only the resources to be replicated are declared as having a control point. Resources that are not to be replicated to other systems are either not mentioned in the control point definitions or are additionally listed in exclusion tables.

MSS 72 has the intelligence to only operate on those subscriber system resources that deviate from the publisher system resources. This minimizes the amount of time needed to synchronize and thereby increases the number of systems that can be synchronized in a limited time.

The understanding of the concept of a “globally unique resource” is important. ACD agent IDS will be used now to illustrate this importance. If an agent ID can be dialed from anywhere in the ACD enterprise and it always reaches the same agent then it is unique and it can be synchronized from a control point to any other ACD. If the same agent ID represents two different agents on different ACD “subsets” within the ACD enterprise then it is unique within that sub-enterprise. Each can be synchronized from the individual agent's control point to the other ACDs within the same sub-enterprise. It is the responsibility of the MSS administrator to ensure the synchronization configuration does not cross sub-enterprise boundaries. There may be ACDs in the ACD enterprise that are not members of either sub-enterprise.

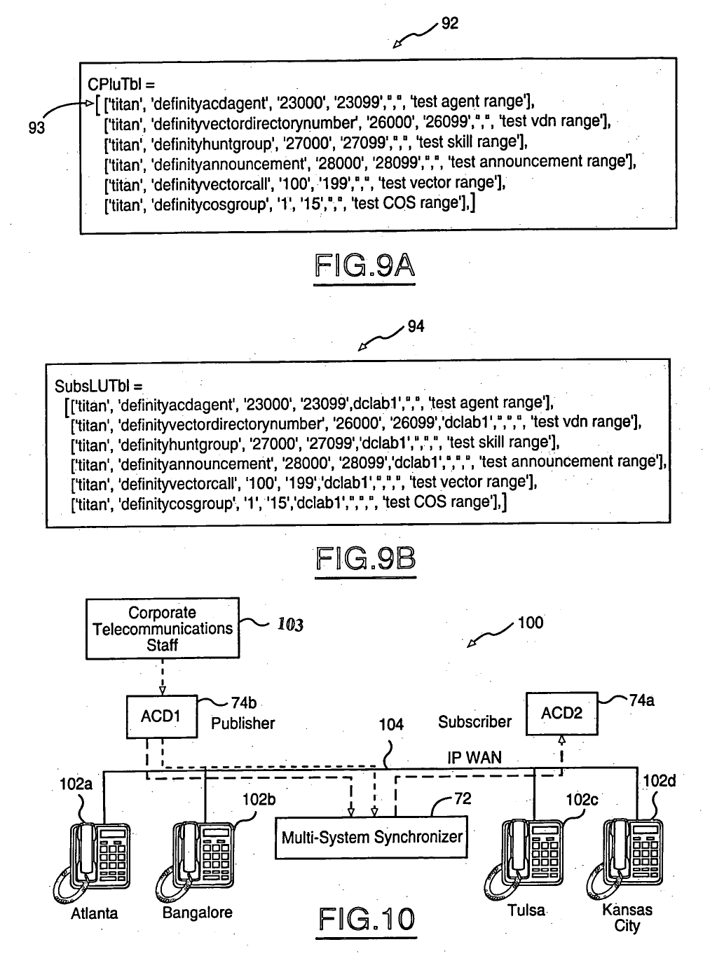

Referring now to FIGS. 9A and 9B, with continual reference to FIGS. 7 and 8, control points and subscriptions tables which show the configuration of ACD resources to be synchronized between publisher ACDs and subscriber ACDs in accordance with the present invention are shown. FIG. 9A illustrates a control points table 92 which publishes all the resources available for synchronization. FIG. 9B illustrates a subscriptions table which defines how the published resources will be mapped from a publisher ACD onto a subscriber ACD. An exceptions table which defines resources within the control point table which are not to be synchronized may also be employed. Such an exceptions table specifies control points which are to be excluded from publication.

It is noted that the standard synchronization rules engine provided by MSS 72 implements control through such tables. Ranges of resources eligible for synchronization are defined on source (i.e., publisher) systems. Individual exclusions from the ranges are allowed, usually for resources which are unique to one ACD or call center. Changes to an eligible resource are passed through a steering process (still using tables) which defines the replicant (i.e., subscriber) systems.

The table contents configured are the same for the real-time application as well as the audit application of MSS 72. However, the procedures to configure them are different. The tables for the real-time application of MSS 72 are configured in a flat file, whereas the tables for the audit application of MSS 72 are configured using an electronic directory editor software tool.

How the tables are configured for both of the real-time and audit applications of MSS 72 will now be described. Configuring control points table 92 initially includes locating the configuration file in the directory where the real-time application of MSS 72 is installed on applications server 89. This file is then opened and edited using a text editor. Default ACD resources available for synchronization can be predefined in control points table 92. An operator then configures the publisher ACD's name by modifying the first entry in each row; and configures the range of IDs for the resources available for synchronization by modifying the third and fourth entry in each row. A resource's appearance in control points table 92 only makes it available for synchronization. It will not be replicated to any other systems without a subscription table entry referencing the control point.

In the exemplary control points table 92 shown in FIG. 9A, the publisher ACD's name is ‘titan’ and the range IDs available for synchronization to the subscriber ACD are as follows: ACD agent login IDs in the range of extensions 23000-23099; VDNs in the range of 26000-26099; hunt group extensions in the range of 27000-27099; announcement extensions in the range of 28000-28099; vectors in the range of 100-199; and class of service in the range of 1-15. More particularly, for example, in first row 93 of control points table 92 ‘titan’ is the publisher ACD's name, ‘definityacdagent’ is the object class name (and “acdagent” is the resource type), ‘23000’ is the beginning of the range, ‘23099’ is the end of the range, the following “,” is a spot for the effective and inactivation dates, and ‘test agent range’ is a comment.

Configuring subscriptions table 94 includes continuing editing the same configuration file. Again, default ACD resources available for subscription are predefined in subscription table 94. An operator then configures the publisher ACD's name by modifying the first entry in each row; configures the subscriber ACD's name by modifying the fifth entry in each row; and configures the range of IDs for the resources that the subscriber ACD will replicate from the publisher ACD by modifying the third and fourth entries in each row. In the exemplary subscription table 94 shown in FIG. 9B, the publisher ACD's name is ‘titan’ and the subscriber ACD's name is ‘dclab 1’. In this example, subscriber ACD dclab 1 subscribes to a complete range of resources available from the publisher ACD as defined during the configuration of control points table 92. A subscriptions table entry requests replication of a published control point range to a subscriber system. Any published control point may be referenced multiple times for replication to multiple subscriber systems.

Both the real-time and auditing components of MSS 72 automatically check for logical inconsistencies in control points table 92 and subscriptions table 94. This includes subscribing to resource ranges that are not published; and synchronization “loops” that attempt to configure a resource range as both a publisher and a subscriber. If either table contains a logical inconsistency, the real-time and scheduled synchronization components of MSS 72 will note the errors and end without attempting to synchronize which thereby provides a safety feature.

Various failure modes in the voice and data network environments can result in the loss of synchronization between a controlling resource and the replicants. Manual changes to non-controlling resources on replicant systems are also a concern. This is addressed by the scheduled audit process provided by the auditing component of MSS 72. The auditing component of MSS 72 performs the audit (each night for example) to compare the controlling resources to the replicants. The auditing component of MSS 72 notes in a log all deviations and then automatically corrects the deviations. This audit process is valuable in that it provides a powerful and unique means of ensuring an enterprise's continuation of business rules for voice communications systems are uniformly implemented and enforced. The telecommunications staff simply needs to check the night's audit logs to see where problems had occurred and then take the necessary administrative steps to prevent a recurrence.

Referring now to FIG. 10, with continual reference to FIGS. 7 and 8, a telephone call center network 100 in accordance with the present invention is shown. Call center network 100 includes MSS 72 in communication with a subscriber ACD 74a (“ACD2”) and a publisher ACD 74b (“ACD1”). Call center network 100 further includes multiple call center sites 102 in different geographic areas. Agents are located at call center sites 102. An IP WAN 104 interconnects MSS 72, ACDs 74a, 74b, and call center sites 102. Corporate telecommunications staff 103 are in communication with ACD1. Call center sites 102a, 102b use ACD1 as their primary ACD while call center sites 102c, 102d use ACD2 as their primary ACD.

Examples of how MSS 72 synchronizes ACDs 74a, 74b of call center network 100 in accordance with example business rules will now be described. The example business rules include the following: failover ACD1 to ACD2; failover ACD2 to ACD1; synchronize common VDNs 20000-29999 from ACD1 to ACD2; synchronize common vectors 200-999 from ACD1 to ACD2; synchronize agents 30000-39999 from ACD1 to ACD2; and synchronize agents 40000-49999 from ACD2 to ACD1.

A first example is staff 103 adding/changing VDN 21111 on publisher ACD1. Adding/changing VDN 21111 falls under the business rule of synchronizing common VDNs 20000-29999 from ACD1 to ACD2. MSS 72 communicates with ACD1 to be notified of this change. MSS 72 then replicates (in real-time or at a scheduled time) this change to subscriber ACD2 such that VDN 21111 is synchronized on ACD1 and ACD2.

A second example is staff 103 changing agent 31000 on publisher ACD1. This change falls under the business rule of synchronizing agents 3000-39999 from ACD1 to ACD2. MSS 72 communicates with ACD1 to be notified of this change and then replicates this change to subscriber ACD2 such that changed agent 31000 is synchronized on ACD1 and ACD2.

A third example is changing agent 31000 on subscriber ACD2. This change conflicts with the business rule of synchronizing agents 30000-39999 from ACD1 to ACD2. As described above, MSS 72 communicates with ACD1 to see if any changes have been made to ACD1 and the auditing component of the MSS audits ACD2 to see if there are any discrepancies with ACD1. Agent 31000 being changed on ACD2 while remaining the same on ACD1 is such a discrepancy. As such, the auditing component of MSS 72 corrects agent 31000 on ACD2 to conform with ACD1 such that agent 31000 is synchronized on ACD1 and ACD2 after the correction.

A fourth example is a connection failure between ACD1 and the external telephone network. As a result of this failure, ACD1 is inoperable. This failover scenario falls under the business rule of failover ACD1 to ACD2 meaning that ACD2 is to handle the calls which would have been received by call center sites 102a, 102b but for the failure. In this case, as MSS 72 had previously synchronized ACD resources on ACD1 and ACD2, agent 31000 on ACD2, for example, matches ACD1 at the time of the failure. Accordingly, failover ACD2 provides resilient business continuity to call center sites 102a, 102b as a result of the synchronization performed by MSS 72.

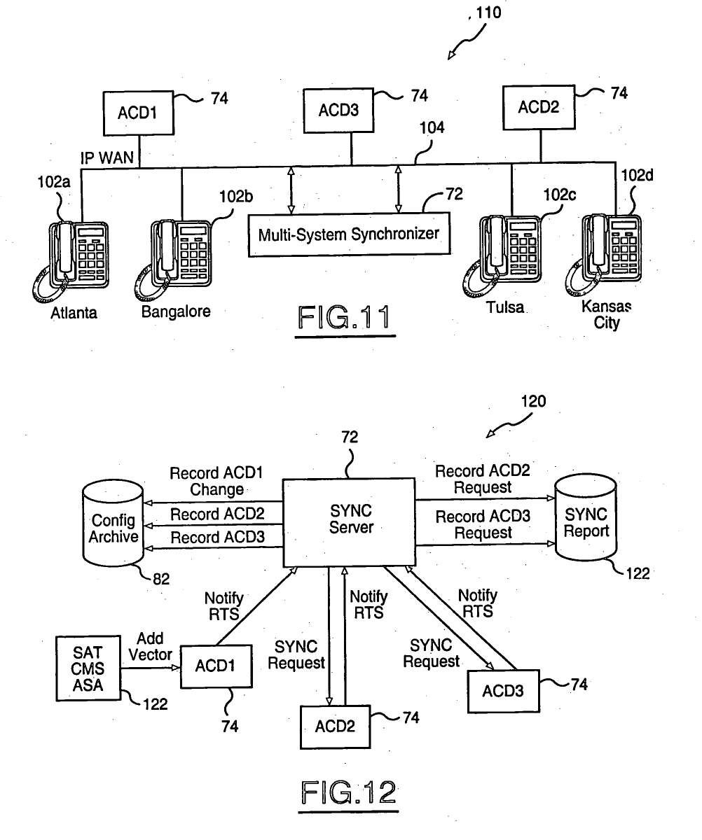

Referring now to FIG. 11, with continual reference to FIGS. 7, 8, and 10, a telephone call center network 110 in accordance with the present invention is shown. MSS 72 is in communication with ACDs 74, namely ACD1, ACD2, and ACD3. Multiple call center sites 102 are located in different geographic areas and IP WAN 104 interconnects MSS 72, ACDs 74, and call center sites 102. Call center sites 102a, 102b use ACD1 as their primary ACD while call center sites 102c, 102d use ACD2 as their primary ACD.

Examples of how MSS 72 synchronizes ACDs 74 of call center network 110 in accordance with example business rules will now be described. The example business rules include the following: ACD3 is the failover server for ACD1 and ACD2; synchronize vectors 200-999 from ACD1 to ACD2 and ACD3; synchronize agents 30000-39999 from ACD1 to ACD3; and synchronize agents 40000-49999 from ACD2 to ACD3.

A first example is the corporate telecommunications staff adding or changing vector 211 on ACD1. This falls under the business rule of synchronizing vectors 200-299 from ACD1 to ACD2 and ACD3. MSS 72 communicates with ACD1 to be notified of this change. MSS 72 then replicates this change to subscriber ACD2 and ACD3 such that VDN 21111 is synchronized on ACD1, ACD2, and ACD3 in accordance with the noted business rule. As a result, calls routed by vector 211 will be handled consistently on all three ACDs.

A second example is the corporate telecommunications staff adding or changing agent 31111. This falls under the business rule of synchronizing agents 3000-39999 from ACD1 to ACD3. MSS 72 communicates with ACD1 to be notified of this change. MSS 72 then replicates this change to subscriber ACD3 such that agent 31111 is synchronized on ACD1 and ACD3 in accordance with the noted business rule.

A third example is a connection failure between ACD1 and the external telephone network. As a result of this failure, ACD1 is inoperable. This failover scenario falls under the business rule of failover ACD1 to ACD3 meaning that ACD3 is to handle the calls which would have been received by call center sites 102a, 102b but for the failure. In this case, as MSS 72 had previously synchronized ACD resources on ACD1 and ACD3, agent 31111 on ACD3, for example, matches ACD1 at the time of the failure. Accordingly, failover ACD3 provides resilient business continuity to call center sites 102a, 102b as a result of the synchronization performed by MSS 72.

Referring now to FIG. 12, with continual reference to FIGS. 8 and 11, a network diagram 120 illustrating the single point of programming provided by MSS 72 for the telephone call center networks in accordance with the present invention is shown. Network diagram 120 illustrates the operation sequence for adding a globally defined vector (such as vector 211 of the first example described with respect to FIG. 11). In operation, an operator at a system administration terminal (SAT) 122 (or call management system (CMS), or ASA, etc.) adds the vector to ACD1. MSS 72 monitors ACD1 and is apprised of the vector. MSS 72 then sends a SYNC request to each of ACD2 and ACD3 (which are subscribers of ACD changes to publisher ACD1). The SYNC request includes the added vector such that this vector is replicated to ACD2 and ACD3. That is, MSS 72 initiates an update of subscriber ACD2 and subscriber ACD 3 and then the synchronization is completed. MSS 72 monitors ACD2 and ACD3 to be sure that the vector has been added to ACD2 and ACD3 and that the vector is synchronized (i.e., the same) among ACD1, ACD2, and ACD3.

MSS 72 sends information indicative of the ACD1 change involving the added vector to CAR 82 for the CAR to archive. MSS 72 also send information indicative of this vector being changed on ACD2 and ACD3 to CAR 82 for the CAR to archive. As such, the synchronization can be observed in real-time or retrieved from CAR 82. It is noted that CAR 82 records all administrative activities whether they are directly or mechanically initiated, and ACD/PBX management environments benefit from its ability to record, retrieve, and display a comprehensive history of telephone system administration activity across the entire enterprise. MSS 72 further sends information indicative of the SYNC requests sent to each of ACD2 and ACD3 to a SYNC reporting database 122. All MSS synchronization events are recorded with their times in SYNC reporting database 122.

In summary, the MSS in accordance with the present invention is an advanced, enterprise-level management tool for ACD and PBX telephone systems. In addition to easing labor intensive administration tasks, the MSS provides two significant benefits: a resilient business continuity plan; and a consistent, quality calling experience for callers. Administratively, the MSS ensures that collections of customer specified resources such as vectors, VDNs, announcement, and stations are uniformly and simultaneously administered across the entire enterprise from a convenient single point of programming. Call center agent login IDs and telephone stations are configured identically on the agent's primary ACD and one or more failover ACDs. This automatic synchronization ensures that the call centers of the call center network will be in full compliance with the business continuity plan for the call center network. If a disaster occurs, not only will agents be able to login to their failover ACD, they will also be configured exactly as they were before the disaster occurred. The calling environment including vectors and VDNs will be identical.

As described, the MSS in accordance with the present invention accelerates agent performance routing updates to maximize benefit through a period of time; reduces or eliminates extensive administration; eliminates duplication of labor intensive operations; eliminates human errors in ACD administration; provides for early detection and correction of deviations from performance routing and disaster recovery polices; enables easy, timely, accurate reporting of ACD configuration; and facilitates disaster recovery.

Thus, it is apparent that there has been provided, in accordance with the present invention, a method and system for automatically synchronizing and auditing databases of telephone call center switching systems in a telephone call center network that fully satisfy the objects, aims, and advantages set forth above. While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A telephone call center system for directing incoming calls from callers to agents, the system comprising:
a first call center switch having a configuration corresponding to call distribution rules such that the first call center switch distributes incoming calls from callers to the agents in accordance with the call distribution rules;
a second call center switch having a configuration; and
a synchronizer in communication with the call center switches for determining the configurations of the call center switches, wherein upon the synchronizer determining that the configuration of the second call center switch is different than the configuration of the first call center switch the synchronizer replicates the configuration of the first call center switch to the second call center switch such that the second call center switch has the same configuration as the first call center switch whereby both call center switches distribute incoming calls to the agents in accordance with the call distribution rules.

2. The system of claim 1 wherein:
in response to the configuration of the first call center switch being changed to a new configuration corresponding to new call distribution rules such that the first call center switch distributes incoming calls from callers to the agents in accordance with the new call distribution rules, the synchronizer replicates the new configuration of the first call center switch to the second call center switch such that the second call center switch has the new configuration whereby both call center switches distribute incoming calls to the agents in accordance with the new call distribution rules.

3. The system of claim 1 wherein:
in response to the configuration of the second call center switch being changed to a configuration which is different than the configuration of the first call center switch, the synchronizer replicates the configuration of the first call center switch to the second call center switch such that the second call center switch has the same configuration as the first call center switch whereby both call center switches distribute incoming calls to the agents in accordance with the call distribution rules.

4. The system of claim 1 further comprising:
a third call center switch having a configuration;
wherein the synchronizer is in communication with the third call center switch for determining the configuration of the third call center switch, wherein upon the synchronizer determining that the configuration of the third call center switch is different than the configuration of the first call center switch the synchronizer replicates the configuration of the first call center switch to the third call center switch such that the third call center switch has the same configuration as the first call center switch whereby the call center switches distribute incoming calls to the agents in accordance with the call distribution rules.

5. The system of claim 1 wherein:
the first and second call center switches comprise automatic call distributor switches.

6. The system of claim 5 wherein:
each automatic call distributor switch includes a media server and a media gateway which communicate with one another to form an automatic call distributor.

7. The system of claim 4 wherein:
the first, second, and third call center switches comprise automatic call distributor switches.

8. The system of claim 5 wherein:
the first, second, and third call center switches comprise private branch exchange switches.

9. The system of claim 1 wherein:
call center switch resources such as agent logins, vectors, virtual directory numbers, hunt groups, and announcements of the first call center switch are set in accordance with a resource group setting such that the first call center switch has the configuration corresponding to the call distribution rules;
wherein synchronizer replicates the configuration of the first call center switch to the second call center switch such that the call center switch resources of the second call center switch are set in accordance with the resource group setting whereby both call center switches have the same configuration.

10. The system of claim 2 wherein:
call center switch resources such as agent logins, vectors, virtual directory numbers, hunt groups, and announcements of the first call center switch are set in accordance with a new resource group setting such that the first call center switch has the new configuration corresponding to the new call distribution rules;
wherein synchronizer replicates the new configuration of the first call center switch to the second call center switch such that the call center switch resources of the second call center switch are set in accordance with the new resource group setting whereby both call center switches have the same new configuration.

11. A system for use with a telephone call center network having a plurality of call center switches for directing incoming calls from callers to agents, the system comprising:
a control points table indicating which one of the switches is a publisher of a first resource and which one of the switches is a publisher of a second resource;
a subscriptions table indicating which of the switches are subscribers of the first resource publisher and which of the switches are subscribers of the second resource publisher; and
a synchronizer in communication with the switches and the tables, wherein the synchronizer replicates the first resource of the first resource publisher to the subscribers of the first resource publisher and replicates the second resource of the second resource publisher to the subscribers of the second resource publisher in accordance with the indications of the tables.

12. The system of claim 11 wherein:
the switches comprise automatic call distributor switches.

13. The system of claim 111 wherein:
the resources include at least one of agent logins, vectors, virtual directory numbers, hunt groups, and announcements.

14. The system of claim 11 wherein:
the control points table further indicates the first resource of the first resource publisher;
wherein, in response to a call systems administrator accessing the call distribution rules to modify the first resource, the synchronizer replicates the modified first resource to the subscribers of the first resource publisher.

15. The system of claim 11 wherein:
in response to the first resource of a subscriber of the first resource publisher being changed such that the first resource of the subscriber is different than the first resource of the first resource publisher, the synchronizer replicates the first resource of the first resource publisher to the subscriber such that the first resource of the subscriber is the same as the first resource of the first resource publisher.

16. A method for a telephone call center system operable for directing incoming calls from callers to agents, the method comprising:
providing a first call center switch having a configuration corresponding to call distribution rules such that the first call center switch distributes incoming calls from callers to the agents in accordance with the call distribution rules;
providing a second call center switch having a configuration;
communicating with the call center switches to determine the configurations of the call center switches using a synchronizer in communication with the call center switches;
upon determining that the configuration of the second call center switch is different than the configuration of the first call center switch, replicating the configuration of the first call center switch from the synchronizer to the second call center switch such that the second call center switch has the same configuration as the first call center switch whereby both call center switches distribute incoming calls to the agents in accordance with the call distribution rules.

17. The method of claim 16 further comprising:
in response to the configuration of the first call center switch being changed to a new configuration corresponding to new call distribution rules such that the first call center switch distributes incoming calls from callers to the agents in accordance with the new call distribution rules, replicating the new configuration of the first call center switch from the synchronizer to the second call center switch such that the second call center switch has the new configuration whereby both call center switches distribute incoming calls to the agents in accordance with the new call distribution rules.

18. The method of claim 16 further comprising:
in response to the configuration of the second call center switch being changed to a configuration which is different than the configuration of the first call center switch, replicating the configuration of the first call center switch from the synchronizer to the second call center switch such that the second call center switch has the same configuration as the first call center switch whereby both call center switches distribute incoming calls to the agents in accordance with the call distribution rules.

19. The method of claim 16 further comprising:
providing a third call center switch having a configuration;
communicating with the third call center switch to determine the configuration of the third call center switch using the synchronizer; and
upon determining that the configuration of the third call center switch is different than the configuration of the first call center switch replicating the configuration of the first call center switch from the synchronizer to the third call center switch such that the third call center switch has the same configuration as the first call center switch whereby the call center switches distribute incoming calls to the agents in accordance with the call distribution rules.

20. The method of claim 16 wherein:
the first and second call center switches comprise automatic call distributor switches.
